(19) United States
(12) Patent Application Publication
(10) Pub. No.: US 2025/0265628 A1
(43) Pub. Date: Aug. 21, 2025

(54) SELECTING REPLACEMENT ITEMS FOR AN ORDER BASED ON MACHINE-LEARNED PREDICTIONS OF POSITIVE AND NEGATIVE EVENTS

(71) Applicant: Maplebear Inc., San Francisco, CA (US)

(72) Inventors: Ahsaas Bajaj, Santa Clara, CA (US); Shishir Kumar Prasad, Fremont, CA (US); Allan Stewart, Berkeley, CA (US); Viswa Mani Kiran Peddinti, San Francisco, CA (US); Ashish Sinha, Jersey City, NJ (US); Alysia Echevarria, New York, NY (US); Dian Ding, Santa Clara, CA (US)

(21) Appl. No.: 18/444,498

(22) Filed: Feb. 16, 2024

(51) Int. Cl. G06Q 30/0601; G06Q 10/087; G06Q 30/0202

(52) U.S. Cl. CPC G06Q 30/0631; G06Q 10/087; G06Q 30/0202; G06Q 30/0635

(57) ABSTRACT

An online concierge system receives orders and allocates orders to pickers who obtain items in an order from a retailer and deliver the items to a customer from whom the order was received. When an item included in an order is unavailable, the online concierge system suggests one or more replacement items for the item. To select a replacement item for an unavailable item, the online concierge system uses a set of models trained to predict a probability or each of a set of events, including one or more negative events, for a candidate replacement item. The online concierge system generates a score for a candidate replacement item as a weighted combination of the predicted probabilities, with negative weights applied to the probabilities for negative events. Based on the scores for various candidate replacement products, the online concierge system selects one or more candidate replacement items for an item.

### BACKGROUND

Online concierge systems receive orders from customers for items offered by a retailer and allocate an order to a picker for fulfillment. To fulfill an order, a picker to whom the order was allocated obtains items in the order from a retailer identified by the order. Subsequently, the picker delivers the obtained items to a customer from whom the order was received.

Because pickers obtain items for orders from retailers, availability of items at a retailer affects an ability of a picker to fulfill an order. For example, when one or more items included in an order are out of stock or otherwise unavailable at a retailer, a picker cannot include those items in the order. To maintain customer satisfaction, many online concierge systems provide a refund or another type of credit to a customer for one or more items included in an order that are unavailable at a retailer. While this enables a customer to receive other items in an order when an item in the order is unavailable, refunding or crediting the customer for the unavailable item decreases revenue to an online concierge system from fulfilling the order.

Some online concierge systems allow a customer to identify a replacement item for an item that is unavailable at a retailer. When the item is unavailable, a picker fulfilling an order including the item replaces the item with the replacement item. To simplify identification of replacement items, an online concierge system may apply a trained model to different candidate replacement items, generating scores used to select one or more candidate replacement items. For example, an online concierge system displays candidate replacement items in an order based on their corresponding scores determined by the trained model. Models applied to candidate replacement items by conventional online concierge systems are trained to maximize probabilities of positive events, such as including a candidate replacement item in an order, occurring when a candidate replacement item is presented to a customer. However, these conventionally trained models undervalue occurrences of negative events, such as receiving requests for refunds or receiving negative feedback about a candidate replacement item, when a candidate replacement item is included in an order. While scores for candidate replacement items generated by conventionally trained models identify candidate replacement items more likely to be selected by customers for inclusion in order, identifying candidate replacement items using the conventionally-generated scores may also increase frequencies with which negative events, such as requests for refunds or receipt of negative feedback, occur when including replacement items in an order. Such an increased occurrence of negative events reduces a number of subsequent orders received by the online concierge system from users. As a result, in the technical context, using candidate replacement items obtained from scores generated by conventionally trained machine learning models may lead to inaccurate results.

### SUMMARY

In accordance with one or more aspects of the disclosure, an online concierge system receives an order from a customer. The order includes one or more items and identifies a retailer from which the one or more items are to be obtained. In various embodiments, the order includes a location and a time interval for delivery of the one or more items included in the order, although different or additional information may be included in the order in various embodiments.

The online concierge system allocates the order to a picker, who obtains the items included in the order from the retailer identified by the order. For example, the picker selects the order from the online concierge system and obtains the items included in the order from the retailer identified in the order. In other embodiments, the online concierge system allocates the order to the picker for fulfillment from the retailer identified by the order using one or more allocation methods.

As the picker obtains items included in the order from the retailer identified by the order, one or more items included in the order may be unavailable from the retailer. For example, an item included in the order has low inventory at the retailer when the customer creates the order, and the item is subsequently sold out when the picker is fulfilling the order. As another example, inventory information the online concierge system receives from a retailer is not current, so the customer includes an item in the order that is out of stock at the retailer. The online concierge system allows a picker to replace an unavailable item, which is an item that is not available at a retailer or that has less than a threshold predicted availability at the retailer, with a replacement item. Allowing a picker to obtain a replacement item in place of the unavailable item allows the online concierge system to prevent losing revenue from refunding a customer for the unavailable item in the order.

To simplify selection of a replacement item, when the online concierge system identifies an unavailable item in the order, the online concierge system obtains a set of candidate replacement items for the unavailable item. In some embodiments, the set of candidate replacement items includes items having a common item category with the unavailable item. In other embodiments, the set of candidate replacement items includes items that the customer or one or more other customers have previously included in orders in place of the unavailable item. For each candidate replacement item, the online concierge system generates a score by applying a trained replacement selection model to each pair of the unavailable item and a candidate replacement item of the set. The replacement selection model determines a predicted probability of multiple events occurring when the unavailable item is replaced by a candidate replacement item based on item attributes of the unavailable item and of the candidate replacement item. The replacement selection model generates the score for the candidate replacement item as a weighted combination of the predicted probabilities of different events occurring when replacing the unavailable item with the candidate replacement item.

The replacement selection model determines a predicted probability of the customer approving replacement of the unavailable item with the candidate replacement item, and determines an approval score for the candidate replacement item based on a number of times the unavailable item was replaced by the candidate replacement item in prior orders and a number of times the unavailable item was replaced in prior orders. Additionally, the replacement selection model determines a predicted probability of one or more negative events occurring in response to replacing the unavailable item with the candidate replacement item, so the replacement selection model accounts for the customer having a negative reaction to replacing the unavailable item with the candidate replacement item. In various embodiments, a “negative event” comprises the online concierge system receiving negative feedback from the customer when the candidate replacement item is included in the order in place of the unavailable item or the online concierge system receiving a request for a refund for the candidate replacement item when included in an order in place of the unavailable item. However, in other embodiments, other actions or interactions by the customer comprise a negative event.

When generating a score for a candidate replacement item, the replacement selection model applies different weights to different predicted probabilities, with the replacement selection model applying a negative weight to predicted probabilities of negative events occurring and applying a positive weight to predicted probabilities of other (i.e., non-negative) events occurring. In other embodiments, weights applied to predicted probabilities of non-negative events have a different sign than weights applied to probabilities of one or more negative events occurring. The replacement selection sums, or otherwise combines, the weighted predicted probabilities for a candidate replacement item to generate a score for the candidate replacement item. Such a configuration allows scores for the candidate replacement item to account for probabilities of one or more negative events occurring when the unavailable item is replaced by the candidate replacement item. This allows the replacement selection model to account for both negative events and non-negative events potentially caused by replacing the unavailable item with the candidate replacement item.

Based on the scores generated for each candidate replacement items of the set, the online concierge system selects one or more candidate replacement items. For example, the online concierge system ranks the candidate replacement items by their corresponding scores and selects one or more candidate replacement items having at least a threshold position in the ranking. In an example, the online concierge system ranks the candidate replacement items of the set so candidate replacement items with larger scores have higher positions in the ranking and selects one or more candidate replacement items having at least the threshold position in the ranking. Alternatively, the online concierge system selects one or more candidate replacement items having a score equaling or exceeding a threshold score.

The online concierge system displays the selected one or more candidate replacement items to a user of the online concierge system associated with the order. For example, the online concierge system transmits instructions for generating an interface displaying one or more of the selected candidate replacement items to a customer client device of the customer from whom the order was received. The customer may identify a particular candidate replacement item for replacing the unavailable item through interaction with the interface via the customer client device. In some embodiments, the interface displays the selected candidate replacement items in an order based on their corresponding scores. For example, the interface displays selected candidate replacement items with higher scores in more prominent positions in the interface, while displaying selected candidate replacement items with lower scores in less prominent positions in the interface.

Alternatively or additionally, the online concierge system transmits instructions for generating an interface displaying one or more of the selected candidate replacement items to a picker client device of a picker fulfilling the order. In some embodiments, the interface displays the selected candidate replacement items in an order based on their corresponding scores. For example, the interface displays selected candidate replacement items with higher scores in more prominent positions in the interface, while displaying selected candidate replacement items with lower scores in less prominent positions in the interface. Displaying the selected candidate replacement items in an order based on their generated scores increases a likelihood of the picker replacing the unavailable item with a candidate replacement item that the customer will approve, while reducing the probability of a negative event occurring from replacement of the unavailable item.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for selecting one or more candidate replacement items for an item included in an order using a trained replacement selection model, in accordance with one or more embodiments.

FIG. 4 is a conceptual diagram of a replacement selection model, in accordance with one or more embodiments.

FIG. 5 is a conceptual diagram of an alternative replacement selection model, in accordance with one or more embodiments.

FIG. 6 is a conceptual diagram of another replacement selection model, in accordance with one or more embodiments.

FIG. 7 is a process flow diagram of a method for selecting one or more candidate replacement items for an unavailable item in an order, in accordance with one or more embodiments.

### DETAILED DESCRIPTION

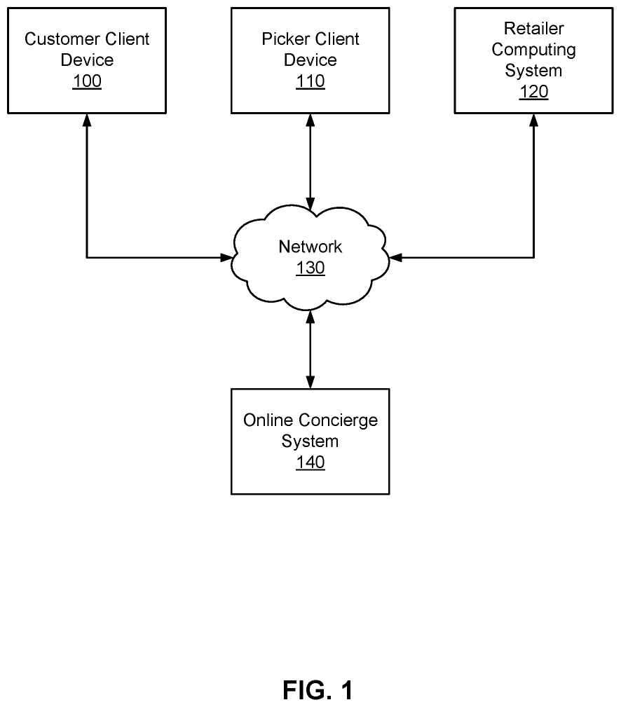

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered.

Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

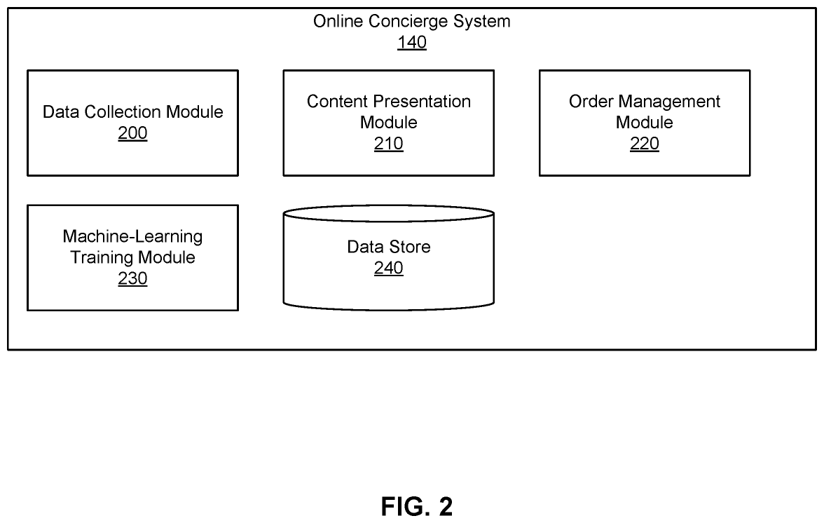

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, order data includes information identifying an item in an order that was unavailable at a retailer and a replacement item included in the order in place of the unavailable item. Order data may also include indications of feedback about a replacement item included in the order, such as positive feedback indicating a customer was satisfied with the replacement item or negative feedback indicating the customer was dissatisfied with the replacement item.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

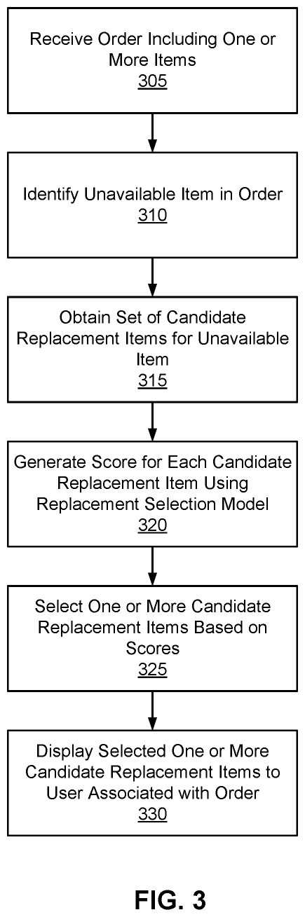

In various embodiments, the order management module 220 displays one or more candidate replacement items for an item included in the order that was unavailable at a retailer (i.e., an “unavailable item”). As further described below in conjunction with FIGS. 3-7, the candidate replacement items displayed are selected based on predicted probabilities of different events occurring when replacing the unavailable item with the candidate replacement item. The order management module 220 transmits instructions to a customer client device 100 for a customer from whom an order was received to generate an interface displaying one or more candidate replacement items selected as further described below in conjunction with FIGS. 3-7 to the customer, allowing the customer to select a candidate replacement item for replacing the unavailable item. Additionally or alternatively, the order management module 220 transmits instructions to a picker client device 110 for a picker fulfilling the order to generate an interface displaying one or more candidate replacement items selected as further described below in conjunction with FIGS. 3-7 to the picker, allowing the picker to select a candidate replacement item for replacing the unavailable item.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The machine learning training model 230 trains a replacement selection model that receives an item and a candidate replacement item and generates a score for the candidate replacement item. As further described below in conjunction with FIGS. 3-7, the replacement selection model generates the score by predicting probabilities of different events occurring when the item is replaced by the candidate replacement item, applying weights to different predicted probabilities, and combining the weighted predicted probabilities. For example, the score is a sum of the weighted predicted probabilities. One or more of the events for which probabilities are predicted are negative events. In various embodiments, a “negative event” comprises the online concierge system receiving negative feedback from the customer when the candidate replacement item is included in the order in place of the unavailable item or the online concierge system receiving a request for a refund for the candidate replacement item when included in an order in place of the unavailable item. However, in other embodiments, other actions or interactions by the customer comprise a negative event. When weighting the predicted probabilities, weights for predicted probabilities for negative events have a different sign than weights for other events. For example, negative weights are applied to predicted probabilities for negative events, while positive weights are applied to predicted probabilities for other events.

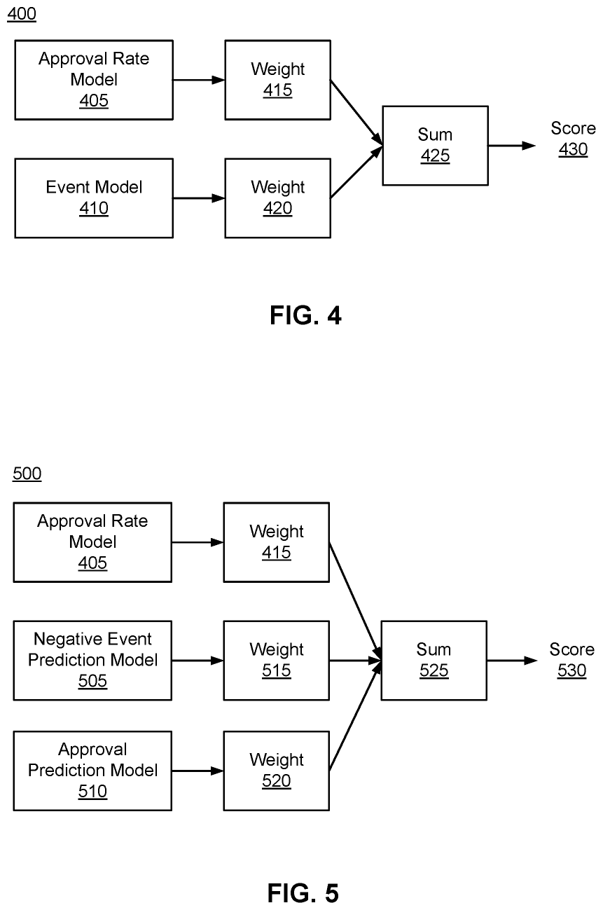

As further described below in conjunction with FIGS. 4-7, the replacement selection model may include different models that generate predicted probabilities of different events occurring based on an input of an item and a replacement item. The machine learning training module 230 trains each model by applying the model training examples that each include an item and a replacement item to generate a predicted probability of an event occurring when the item is replaced by the candidate replacement item, with a label applied to a training example indicating whether an event occurred when the item was replaced by the candidate replacement item. The machine learning training module 230 scores the predicted probability output by the model using a loss function that generates a score for the predicted probability that is higher when a difference between the predicted probability and a label applied to the training example is larger and is smaller when the difference between the predicted probability and the label applied to the training example is smaller. Example loss functions include the mean square error function, the mean absolute error, hinge loss function, and the cross-entropy loss function. The machine learning training module 230 updates the set of parameters for the model based on the score generated by the loss function. For example, the machine learning training module 230 may apply gradient descent to update the set of parameters. The machine learning training module 230 iteratively updates parameters of the model based on scores from the loss function until one or more criteria are satisfied in various embodiments.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart for a method of a method for selecting one or more candidate replacement items for an item included in an order using a trained replacement selection model, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

An online concierge system 140 receives 305 an order from a customer that includes one or more items and identifies a retailer from which the one or more items are to be obtained. The online concierge system 140 allocates the order to a picker, who obtains the items in the order from the retailer identified by the order. The picker fulfills the order by delivering the items included in the order to a location specified by the order.

As the picker obtains items in the order from a retailer, one or more items included in the order may be unavailable from the retailer identified by the order when the picker fulfills the order. For example, an item included in the order has low inventory at the retailer when the customer creates the order, and the item is subsequently sold out at the retailer when the picker is fulfilling the order. As another example, inventory information the online concierge system 140 receives from a retailer is not current, so a customer includes an item in the order that is out of stock at the retailer. When the picker obtains items for the order (or prior to the picker obtaining items for the order), the online concierge system 140 identifies 310 an item in the order that is unavailable at the retailer identified by the order (an “unavailable item”). For example, the online concierge system 140 receives a notification from the picker fulfilling the order identifying an unavailable item. As another example, the online concierge system 140 applies an availability model to each item in the order and identifies 310 one or more unavailable items based on output of the availability model for an item. As further described above in conjunction with FIG. 2, the availability model predicts a likelihood that an item is available at the retailer identified by the order or predicts an estimated number of items that are available at the retailer identified by the order. The online concierge system 140 identifies 310 an unavailable item as an item having less than a likelihood of being available at the retailer identified by the order in some embodiments. As another example, the online concierge system 140 identifies 310 an unavailable item as an item having less than a threshold estimated number of items available at the retailer identified by the order. However, in other embodiments, the online concierge system 140 identifies 310 an unavailable item in the order using one or more alternative or additional methods.

The online concierge system 140 allows the picker fulfilling the order to include a replacement item in the order in place of the unavailable item. Allowing a picker to obtain a replacement item in place of the unavailable item prevents the online concierge system 140 from losing revenue from the order by refunding a customer for the unavailable item. To simplify selection of a replacement item by the customer or by the picker fulfilling the order, the online concierge system 140 obtains 315 a set of candidate replacement items for the unavailable item. In some embodiments, the set of candidate replacement items includes items having a common item category with the unavailable item. In other embodiments, the set of candidate replacement items includes items that the customer or other customers have previously included in orders in place of the unavailable item. In other embodiments, the online concierge system 140 obtains 315 the set of candidate replacement items satisfying additional or alternative criteria.

To increase a likelihood of a replacement item being satisfactory to the customer from whom the order was received, which decreases a likelihood of the customer requesting a refund for the replacement item, the online concierge system 140 leverages a trained replacement selection model to determine presentation of candidate replacement items to the customer or to the picker. Using the trained replacement selection model to organize or to select candidate replacement items for display, the online concierge system 140 reduces an amount of time for the customer to or for the picker to select a replacement item for the unavailable item. This prevents the customer or the picker from navigating through a large number of candidate replacement items. As further described below in conjunction with FIGS. 4-7, the replacement selection model accounts for different events, including one or more negative events, capable of occurring when a candidate replacement item is included in the order in place of the unavailable item. A “negative event” occurs when the online concierge system 140 receives negative feedback from the customer when the candidate replacement item is included in the order in place of the unavailable item or when the online concierge system 140 receives a request for a refund for the candidate replacement item when included in an order in place of the unavailable item, in various embodiments. For example, negative feedback for a candidate replacement item comprises an indication from a customer that the candidate replacement item was an inadequate replacement or the unavailable item or an indication from the customer that the candidate replacement item had less than a threshold quality to the customer. In other embodiments, different actions by a customer comprise negative events.

The online concierge system 140 applies the replacement selection model to each combination of the unavailable item and a candidate replacement item of the set. Application of the replacement selection model to the unavailable item and to the candidate replacement item generates 320 a score for the candidate replacement item. In various embodiments, the replacement selection model is an ensemble model that weights outputs of different sub-models and combines the weighted outputs of the multiple sub-models to generate 320 the score for a candidate replacement item. Different sub-models predict a probability of different events occurring when the candidate replacement item replaces the unavailable item. For example, the replacement selection model includes an approval rate model and one or more event models. In some embodiments, the replacement selection model includes the approval rate model, a positive event model, and a negative event model, while in other embodiments, the replacement selection model includes the approval rate model and a multitask learning model accounting for negative events and approval of the candidate replacement item in place of the unavailable item. The replacement selection model applies weights to output of each of the approval rate model and the one or more event models, with a score generated 320 by the replacement selection model comprising the weighted sum of the outputs of the approval rate model and the one or more event models. The replacement selection model applies weights having a first sign to predicted probabilities for negative events and applies weights having a different second sign to predicted probabilities for other events.

For purposes of illustration, FIG. 4 is a conceptual diagram of one or more embodiments of the approval rate model 400. In the example of FIG. 4, the approval rate model 400 includes an approval rate model 405 and an event model 410 for purposes of illustration. However, in other embodiments, the approval rate model 400 includes a different number of models than shown in FIG. 4.

The replacement selection model 400 receives a pair of an item and a candidate replacement item as an input. For the pair of the item and the candidate replacement item, the approval rate model 405 determines an approval rate at which the candidate replacement item was approved by customers as a replacement for the item based on prior orders fulfilled by the online concierge system 140. In some embodiments, the approval rate model 405 determines the approval rate as a ratio of a number of times customers previously approved replacing the item with the candidate replacement item in prior orders to a number of times the item was replaced in prior orders. In various embodiments, the approval rate model 405 adjusts the ratio by a confidence factor, with the confidence factor based on the number of times customers previously approved replacing the item with the candidate replacement item. For example, the confidence factor adjusts the ratio by a smaller amount when the number of times customers previously approved replacing the item with the candidate replacement item in prior orders is larger and adjusts the ratio by a larger amount when the number of times customers previously approved replacing the item with the candidate replacement item in prior orders is lower.

However, accounting for approval of replacing the item with the candidate replacement item does not account for negative events occurring because of replacing the item with the candidate replacement item. Without accounting for negative events caused by inclusion of the candidate replacement item in an order rather than the item, the recommendation selection model 400 may increase a frequency with which negative events occur from replacing items. As further described above, a “negative event” occurs when the online concierge system 140 receives negative feedback from the customer when the candidate replacement item is included in the order in place of the item or when the online concierge system 140 receives a request for a refund for the candidate replacement item when included in an order in place of the item in various embodiments.

To account for negative events occurring in response to replacing the item in the pair with the candidate replacement item in the pair, the approval rate model 405 determines a probability of a negative event occurring from replacing the item with the candidate replacement item. The approval rate model 405 determines the probability of one or more negative events occurring in response to replacing the item with the candidate replacement item based on a number of negative events that occurred when the item was replaced by the replacement item and a number of positive events that occurred when the item was replaced by the replacement item. A “positive event” occurs when the online concierge system 140 receives positive feedback from a customer in response to the candidate replacement item replacing the item. In various embodiments, the approval rate model 405 determines the probability of one or more negative events occurring by dividing a number of negative events that previously occurred from replacing the item with the candidate replacement item by a sum of the number of negative events that previously occurred and a number of positive events that previously occurred from replacing the item with the candidate replacement item. In some embodiments, the approval rate model 405 determines the probability of one or more negative events occurring for a pair of the item and the candidate replacement item in response to the online concierge system 140 storing at least a threshold number of negative events in association with the pair of the item and the candidate replacement item and storing at least an additional threshold number of aggregated positive events and negative events in association with the pair of the item and the candidate replacement item. In response to the online concierge system 140 storing less than the threshold number of negative events in association with the pair of the item and the candidate replacement item or storing less than the additional threshold number of aggregated positive events and negative events in association with the pair of the item and the candidate replacement item, the approval rate model 405 does not determine the probability of one or more negative events occurring for the pair of the item and the candidate replacement item, in various embodiments.

Based on the ratio of the number of times customers previously approved replacing the item with the candidate item in prior orders to the number of times the item was replaced in prior orders and the probability of one or more negative events occurring for the pair of the item and the candidate replacement item, the approval rate model 405 generates an approval score. In various embodiments, the approval score is the ratio of the number of times customers previously approved replacing the item with the candidate item in prior orders to the number of times the item was replaced in prior orders. In other embodiments, the approval rate model 405 determines a non-negative event probability from replacing the item with the candidate replacement item by subtracting the probability of one or more negative events occurring from one, and generates the approval score as a product of the ratio and a value based on the non-negative event probability. In some embodiments, the approval rate model 405 maintains a default probability of a non-negative event occurring for determining the approval score when a probability of one or more negative events occurring is not determined for a pair of the item and the candidate replacement item (e.g., when less than the threshold number of negative events are stored in association with the pair of the item and the candidate replacement item).

While the approval rate model 405 leverages stored feedback for replacing the item of the pair with the candidate replacement item of the pair and stored approvals of replacing the item with the candidate replacement item, various items or candidate replacement items may be infrequently selected by customers. Such infrequent selection of an item or a candidate replacement item limits the amount of stored feedback or approvals for use by the approval rate model 405, reducing an accuracy of the approval rate model 405. To mitigate effects of limited interactions stored in association with the item or with the candidate replacement item and to supplement information from received feedback or approvals about replacing the item with the candidate replacement item, the replacement selection model 400 includes the event production model 410. The event production model 410 receives the pair of the item and the candidate replacement item and retrieves item attributes stored in association with the candidate replacement item and with the item from the data store 240.

In various embodiments, the event prediction model 410 receives an embedding for the item of the pair and an embedding for the candidate replacement item of the pair as input. In other embodiments, the event prediction model 410 includes a set of layers that generates an embedding for the item and generates an embedding for the candidate replacement item. An embedding represents the item or represents the candidate replacement item in a high-dimensional space based on various item attributes. Example item attributes from which an embedding is generated include a name of the item, an identifier of a brand associated with the item, an item category associated with the item, a type associated with the item, a cost of the item, or information describing other features of the item. In some embodiments, an embedding of a search query for which the item was selected is included as an item attribute when generating an embedding. From the embedding for the item of the pair and the embedding for the candidate replacement item of the pair, the event prediction model 410 outputs a probability of a customer approving replacement of the item of the pair with the candidate replacement item of the pair.

The online concierge system 140 trains the event prediction model 410 using a training dataset including multiple training examples generated from previously fulfilled orders. Each training example includes an item included in a previously fulfilled order and a replacement item included in the previously fulfilled order in place of the item included in the training example. A label is applied to each training example, with the label indicating whether a customer approved or did not approve replacing the item included in the training example with the replacement item included in the training example. For example, a label for a training example has a first value in response to a customer having approved replacing the item in the training example with the replacement item included in the training example and has a different second value in response to the customer not having approved replacing the item in the training example with the replacement item included in the training example. In some embodiments, a set of training examples includes various pairs of items and replacement items that each have a probability of one or more negative events occurring, determined by the approval rate model 405 as further described above, equaling or exceeding a threshold value. Including training examples with pairs of item and replacement item having greater than the probability of one or more negative events occurring allows the training dataset to incorporate negative signals into training of the event prediction model 410 with certain training examples.

The event prediction model 410 comprises a set of weights stored on a non-transitory computer readable storage medium in various embodiments. For training, the online concierge system 140 initializes a network of a plurality of layers comprising the event prediction model 410, with each layer including one or more weights. The event prediction model 410 receives an item and a candidate replacement item as inputs and outputs a predicted probability of a customer approving replacement of the item with the candidate replacement item.

After initializing the set of weights comprising the event prediction model 410, the online concierge system 140 trains the event prediction model 410 by applying the event prediction model 410 to multiple training examples of the training dataset to generate the parameters (e.g., the weights) for the event prediction model 410. As further described above, in various embodiments, a training example includes a combination of an item and a replacement item. A label applied to the training example indicates whether a customer approved replacing the item included in the training example with the replacement item included in the training example. Applying the event prediction model 410 to a training example generates the predicted probability of a customer approving replacement of the item included in the training example with the replacement item included in the training example.

For each training example to which the event prediction model 410 is applied, the online concierge system 140 generates a score comprising an error term based on the predicted probability of a customer approving replacement of the item included in the training example with the replacement item included in the training example and the label applied to the training example. The error term is larger when a difference between the predicted probability of a customer approving replacement of the item included in the training example with the replacement item included in the training example and the label applied to the training example is larger and is smaller when the difference between the predicted probability of a customer approving replacement of the item included in the training example with the replacement item included in the training example and the label applied to the training example is smaller. In various embodiments, the online concierge system 140 generates the error term using a loss function based on a difference between the predicted probability of a customer approving replacement of the item included in the training example with the replacement item included in the training example and the label applied to the training example. Example loss functions include a mean square error function, a mean absolute error, a hinge loss function, and a cross-entropy loss function.

The online concierge system 140 backpropagates the error term to update the set of parameters comprising the event prediction model 410 and stops backpropagation in response to the error term, or in response to the loss function, satisfying one or more criteria. For example, the online concierge system 140 backpropagates the error term through the event prediction model 410 to update parameters of the event prediction model 410 until the error term has less than a threshold value. For example, the online system 140 may apply gradient descent to update the set of parameters. The online concierge system 140 stores the set of parameters comprising the trained event prediction model 410 on a non-transitory computer readable storage medium after stopping the backpropagation.

For the pair of the item and the replacement item, the replacement selection model 400 applies a weight 415 to the approval score generated by the approval rate model 405 for the time and the replacement item and an additional weight 420 to the predicted probability of a customer approving replacement of the item with the candidate replacement item. To generate a score 430 for the candidate replacement item, the replacement selection model 400 in FIG. 4 sums 425 the approval score from the approval rate model 405 weighted by weight 415 and the predicted probability of a customer approving replacement of the item with the candidate replacement item weighted by weight 420. For example, the approval score from the approval rate model 405 is a product of the ratio and a value based on the non-negative event probability, as further described above, so the replacement selection model 400 generates the score 430 for the candidate replacement item as a sum of the approval score weighted by weight 415 and the predicted probability of a customer approving replacement of the item with the candidate replacement item weighted by weight 420. As further described below in conjunction with FIG. 3, the online concierge system 140 uses scores 430 determined for different pairs of the item and different candidate replacement items to identify one or more candidate replacement items.

In some embodiments, the approval rate model 405 generates the approval score based on a number of times customers previously approved replacing the item with the candidate replacement item and a number of times the item was replaced in prior orders, as further described above. Similarly, the approval rate model 405 determines the probability of one or more negative events occurring in response to replacing the item with the candidate replacement item based on a number of negative events that occurred when the item was replaced by the replacement item and a number of positive events that occurred when the item was replaced by the replacement item, as further described above. The replacement selection model 400 accounts for the approval score and the probability of one or more negative events occurring in response to replacing the item with the candidate replacement item when generating score 430 for the candidate replacement item in various embodiments. For example, the replacement selection model 400 generates the score 430 as a sum 425 of the approval score weighted by weight 415, the predicted probability of a customer approving replacement of the item with the candidate replacement item weighted by weight 420, and the probability of one or more negative events occurring weighted by an alternative weight. The alternative weight has a different sign than weight 415 and weight 420 in various embodiments. Alternatively, the replacement selection model 400 determines a non-negative event probability of one or more negative events not occurring by subtracting the probability of the one or more negative events occurring from 1. In such embodiments, the replacement selection model generates the score 430 for the candidate replacement item as a sum 425 of the approval score weighted by weight 415, the predicted probability of a customer approving replacement of the item with the candidate replacement item weighted by weight 420, and the non-negative event probability weighted by an alternative weight, with the alternative weight having a common sign as the weight 415 and the weight 420. As further described below in conjunction with FIG. 3, the online concierge system 140 uses scores 430 for different candidate replacement items to select one or more candidate replacement items for an unavailable item.

While FIG. 4 shows an example replacement selection model 400 including a single event prediction model 410, FIG. 5 shows an alternative replacement selection model 500 including multiple models predicting different events. The alternative replacement selection model 500 includes the approval rate model 405, a negative event prediction model 505, and an approval prediction model 510. However, in other embodiments, the alternative replacement selection model 500 includes a different number of models than shown in FIG. 5.

The alternative replacement selection model 500 receives a pair including an item and a candidate replacement item as inputs. The approval rate model 405 determines an approval rate at which the candidate replacement item was previously approved by customers as a replacement for the item based on replacement of the item with replacement items in prior orders and approvals of replacing the item with the candidate replacement item in prior orders, as further described above in conjunction with FIG. 4. In some embodiments, the approval rate model 405 determines an approval score as a ratio of a number of times the item was replaced with the candidate replacement item in prior orders to a number of times the item was replaced with a replacement item in prior orders. Additionally, the approval rate model 405 determines a probability of one or more negative events occurring for the pair of the item and the candidate replacement item. In various embodiments, the approval rate model 405 determines the probability of one or more negative events occurring by dividing a number of negative events that previously occurred from replacing the item with the candidate replacement item by a sum of the number of negative events that previously occurred from replacing the item with the candidate replacement item and a number of positive events that previously occurred from replacing the item with the candidate replacement item, as further described above in conjunction with FIG. 4. In some embodiments, the approval rate model 405 generates a non-negative event probability of a negative event not occurring by subtracting the probability of the one or more negative event occurring from one and generating the approval score as a product of the ratio and a value based on the non-negative event probability of the negative event not occurring.

To account for potential negative events occurring from replacing the item of the pair with the candidate replacement item included in the pair, the alternative replacement selection model 500 includes a negative event prediction model 505. The negative event prediction model 505 generates a predicted probability of a negative event occurring from replacing the item of the pair with the candidate replacement item of the pair. As further described above, a “negative event” comprises the online concierge system 140 receiving negative feedback from the customer when the candidate replacement item is included in the order in place of the item or the online concierge system 140 receiving a request for a refund for the candidate replacement item when included in an order in place of the item. The negative event prediction model 505 receives the item of the pair and the candidate replacement item of the pair as input and generates a predicted probability of a negative event occurring when replacing the item with the candidate replacement item. In some embodiments, the negative event prediction model 505 receives an embedding for the item and an embedding for the candidate replacement item. Alternatively, the negative event prediction model 505 includes a set of layers that generate an embedding for the item and generate an embedding for the candidate replacement item. An embedding represents the item or the candidate replacement item in a high-dimensional space based on various item attributes. Example item attributes from which an embedding is generated include a name of the item, an identifier of a brand associated with the item, an item category associated with the item, a type associated with the item, a cost of the item, or information describing other features of the item. In some embodiments, an embedding of a search query for which the item was selected is included as an item attribute when generating an embedding.

The negative event prediction model 505 comprises a set of weights stored on a non-transitory computer readable storage medium in various embodiments. For training, the online concierge system 140 initializes a network of a plurality of layers comprising the negative event prediction model 505. The negative event prediction model 505 receives an item and a candidate replacement item as inputs and outputs a predicted probability of a negative event occurring in response to replacing the item with the candidate replacement item in an order.

The online concierge system 140 generates a negative training dataset including multiple negative training examples generated from previously completed orders that included a replacement item in place of an item. Each negative training example includes a negative training item and a negative training replacement item, with a negative training label applied to each negative training example. The negative training label applied to a negative training example indicates whether a negative event occurred when the negative training replacement item was included in a prior order in place of the negative training item. For example, the negative training label has a specific value in response to a negative event occurring when the negative training replacement item replaced the negative training item in a prior order and has an alternative value when a negative event did not occur when the negative training replacement item was included in the prior order in place of the negative training item.

After generating the negative training dataset, the online concierge system 140 initializes a set of weights comprising the negative event prediction model 505 and trains the negative event prediction model 505 by applying the negative event prediction model 505 to multiple negative training examples of the negative training dataset to generate the parameters (e.g., the weights) for the negative event prediction model 505. As further described above, in various embodiments, a negative training example includes a pair of a negative training item and a negative training replacement item. A label applied to the negative training example indicates whether a negative event occurred or did not occur when the negative training replacement item replaced the negative training item in a prior order. Applying the negative event prediction model 505 to a negative training example generates a predicted probability of a negative event occurring when the negative training item included in the negative training example is replaced by the negative training replacement item included in the negative training example.

For each negative training example to which the negative event prediction model 505 is applied, the online concierge system 140 generates a score comprising a negative event error term based on the predicted probability of the negative event occurring when the negative training item included in the negative training example is replaced by the negative training replacement item included in the negative training example and the negative training label applied to the negative training example. The negative event error term is larger when a difference between the predicted probability of the negative event occurring when the negative training item included in the negative training example is replaced by the negative training replacement item included in the negative training example and the negative training label applied to the negative training example is larger and is smaller when the difference between the predicted probability of the negative event occurring when the negative training item included in the negative training example is replaced by the negative training replacement item included in the negative training example and the negative training label applied to the negative training example is smaller. In various embodiments, the online concierge system 140 generates the negative event error term using a loss function based on a difference between the predicted probability of the negative event occurring when the negative training item included in the negative training example is replaced by the negative training replacement item included in the negative training example and the negative training label applied to the negative training example. Example loss functions include a mean square error function, a mean absolute error, a hinge loss function, and a cross-entropy loss function.

The online concierge system 140 backpropagates the negative event error term to update the set of parameters comprising the negative event prediction model 505 and stops backpropagation in response to the negative event error term, or in response to the loss function, satisfying one or more criteria. For example, the online concierge system 140 backpropagates the negative event error term through the negative event prediction model 505 to update parameters of the negative event prediction model 505 until the negative event error term has less than a threshold value. For example, the online system 140 may apply gradient descent to update the set of parameters. The online concierge system 140 stores the set of parameters comprising the trained negative event prediction model 505 on a non-transitory computer readable storage medium after stopping the backpropagation.

In some embodiments, the alternative replacement selection model 500 determines an inferred probability of a negative event not occurring from the predicted probability of the negative event occurring when replacing an item with a replacement item generated by the negative event prediction model 505. For example, the alternative replacement selection model 505 generates the inferred probability of the negative event not occurring by subtracting the predicted probability of the negative event occurring when replacing an item with a replacement item generated by the negative event prediction model 505 from one. Alternatively, the alternative replacement selection model 505 derives one or more other values from the predicted probability of the negative event occurring when replacing an item with a replacement item generated by the negative event prediction model 505.

While the approval rate model 405 leverages prior interactions by customers with prior orders where items were replaced with corresponding replacement items, as further described above in conjunction with FIG. 4, there may be limited interactions by customers with different combinations of item and replacement item. The negative event prediction model 505 leverages item attributes of an item and of a candidate replacement item to determine a predicted probability of a negative event occurring when the candidate replacement item replaces the item. To leverage item attributes of the item and of the replacement item to determine a likelihood of the customer approving replacing the item with the candidate replacement item, the alternative replacement selection model 500 in FIG. 5 includes the approval prediction model 510, which generates a predicted probability of a customer approving replacement of the item with the candidate replacement item based on corresponding item attributes. This allows the replacement selection model 500 to determine, more accurately, a likelihood of a customer approving replacement of an item with a replacement item based on item attributes of the item and of the replacement item by augmenting the approval rate model 405, which is based on prior interactions with prior orders, with information based on item attributes. Leveraging of item attributes via the approval prediction model 510 allows the alternative replacement selection model 500 to offset limited interactions by customers with various combinations of item and replacement item that may limit accuracy of the approval rate model 405.

The approval prediction model 510 receives the item of the pair and the candidate replacement item of the pair and generates a predicted probability of a customer approving replacement of the item with the candidate replacement item. In some embodiments, the approval prediction model 510 receives an embedding for the item and an embedding for the candidate replacement item. Alternatively, the negative approval prediction model 510 includes a set of layers that generate an embedding for the item and generate an embedding for the candidate replacement item. An embedding represents the item or the candidate replacement item in a high-dimensional space based on various item attributes. Example item attributes from which an embedding is generated include a name of the item, an identifier of a brand associated with the item, an item category associated with the item, a type associated with the item, a cost of the item, or information describing other features of the item. In some embodiments, an embedding of a search query for which the item was selected is included as an item attribute when generating an embedding.

The approval prediction model 510 comprises a set of weights stored on a non-transitory computer readable storage medium in various embodiments. For training, the online concierge system 140 initializes a network of a plurality of layers comprising the approval prediction model 510. The approval prediction model 510 receives an item and a candidate replacement item as inputs and outputs a predicted probability of a customer approving replacement of the item with the candidate replacement item in an order.

The online concierge system 140 generates an approval training dataset including multiple approval training examples from previously completed orders that included a replacement item in place of an item. Each approval training example includes an approval training item and an approval training replacement item, with an approval training label applied to each approval training example. The approval training label applied to an approval training example indicates whether a customer approved or did not approve replacement of the positive training item with the approval training replacement item in a prior order. For example, the approval training label has a particular value in response to the customer approving replacement of the approval training item with the approval training replacement item in a prior order and has a different value when the customer did not approve replacement of the approval training item with the approval training replacement item in the prior order.

After generating the approval training dataset, the online concierge system 140 initializes a set of weights comprising the approval prediction model 510 and trains the approval prediction model 510 by applying the approval prediction model 510 to multiple approval training examples of the approval training dataset to generate the parameters (e.g., the weights) for the approval prediction model 510. As further described above, in various embodiments, an approval training example includes a combination of an approval training item and an approval training replacement item. An approval training label applied to the approval training example indicates whether a customer approved replacement of the approval training item with the approval training replacement item. Applying the approval prediction model 510 to an approval training example generates a predicted probability of a customer approving replacement of the approval training item of the approval training example with the approval training replacement item of the approval training example.

For each approval training example to which the approval prediction model 510 is applied, the online concierge system 140 generates a score comprising an approval error term based on the predicted probability of the customer approving replacement of the approval training item included in the approval training example with the approval replacement item included in the approval training example and the approval training label applied to the approval training example. The approval error term is larger when a difference between the predicted probability of the customer approving replacement of the approval training item in the approval training example with the approval training replacement item in the approval training example and the approval training label applied to the approval training example is larger and is smaller when the difference between the approval probability of the customer approving replacement of the approval training item included in the approval training example with the approval training replacement item included in the approval training example and the approval training label applied to the approval training example is smaller. In various embodiments, the online concierge system 140 generates the approval error term using a loss function based on a difference between the predicted probability of the customer approving replacement of the approval training item included in the approval training example with the approval training replacement item included in the approval training example and the approval training label applied to the approval training example. Example loss functions include a mean square error function, a mean absolute error, a hinge loss function, and a cross-entropy loss function.

The online concierge system 140 backpropagates the error term to update the set of parameters comprising the approval prediction model 510 and stops backpropagation in response to the approval error term, or to the loss function, satisfying one or more criteria. For example, the online concierge system 140 backpropagates the approval error term through the approval prediction model 510 to update parameters of the approval prediction model 510 until the approval error term has less than a threshold value. For example, the online system 140 may apply gradient descent to update the set of parameters. The online concierge system 140 stores the set of parameters comprising the trained approval prediction model 510 on a non-transitory computer readable storage medium after stopping the backpropagation.

Hence, the alternative replacement selection model 500 leverages prior interactions by customers via the approval rate model 405 and item attributes of an item and of a candidate replacement item via the negative event prediction model 505 and the approval prediction model 510. The different models comprising the alternative replacement selection model 500 predict probabilities of different events occurring, including negative events. Through the negative event prediction model 505, the alternative replacement selection model 500 accounts for potential negative events by customers in response to replacing an item with a candidate replacement item, while the approval rate model 405 and the approval prediction model 510 determine probabilities of a customer approving replacement of the item with the candidate replacement item. When applied to the pair of the item and the candidate replacement item, the alternative replacement selection model 500 applies a weight 415 to the approval score from the approval rate model 405, applies a weight 515 to the output of the negative event prediction model 505, and applies a weight 520 to the predicted probability of the customer approving replacement of the item with the candidate replacement item. In embodiments where the output of the negative event prediction model 510 is the predicted probability of a negative event occurring with the item is replaced by the candidate replacement item, the weight 515 has an opposite sign than the weight 415 and the weight 515. For example, the weight 515 is negative, while the weight 415 and the weight 520 are positive, so the predicted probability of a negative event occurring from replacing the item with the candidate replacement item mitigates the approval score and the predicted probability of the customer approving replacement of the item with the candidate replacement item. However, in embodiments where the output of the negative event prediction model 505 is an inferred probability of a negative event not occurring, as further described above, weight 415, weight 515, and weight 520 each have a common sign.

In the example of FIG. 5, the alternative replacement selection model 500 sums 525 the approval score weighted by the weight 415, the output of the negative event prediction model 505 weighted by weight 515, and the predicted probability of the customer approving replacement of the item with the candidate replacement item weighted by weight 520 to generate a score 530 for the candidate replacement item. In other embodiments, the alternative approval selection model 500 differently combines the approval score weighted by the weight 415, the output of the negative event prediction model 505 weighted by weight 515, and the predicted probability of the customer approving replacement of the item with the candidate replacement item weighted by weight 520 to generate the score 530 for the candidate replacement item. As further described below in conjunction with FIG. 3, the online concierge system 140 uses scores 530 determined for different candidate replacement items when paired with the item to select one or more candidate replacement items for an unavailable item.

Alternatively, the alternative approval selection model 500 applies weight 415 to an approval score determined by the approval rate model 405 based on the number of times customers approved replacing the item with the candidate replacement item in prior orders and a number of times the item was replaced with prior orders, applies an alternative weight to a non-negative event probability of one or more negative events not occurring by subtracting the probability of the one or more negative events occurring determined by the approval rate model 405 from 1 (i.e., determining the non-negative event probability further described above in conjunction with FIG. 4), applies weight 515 to the predicted probability of a negative event occurring in response to replacing the item with the candidate replacement item from the negative event prediction model 505, and applies weight 515 to the predicted probability of the customer approving replacement of the item with the candidate replacement item. The alternative replacement selection model 500 determines the score 530 for the candidate replacement item by summing 525 the preceding weighted quantities. In other embodiments, the alternative replacement model accounts for the probability of the one or more negative events occurring determined by the approval rate model 405 or a predicted probability of a negative event not occurring generated by subtracting the probability of the negative event occurring from the negative event prediction model 505 from 1 when generating the score 530 for a candidate replacement item. Weights applied to predicted probabilities or probabilities of negative events occurring have an opposite sign than weights applied to predicted probabilities of approvals or of negative events not occurring in various embodiments.

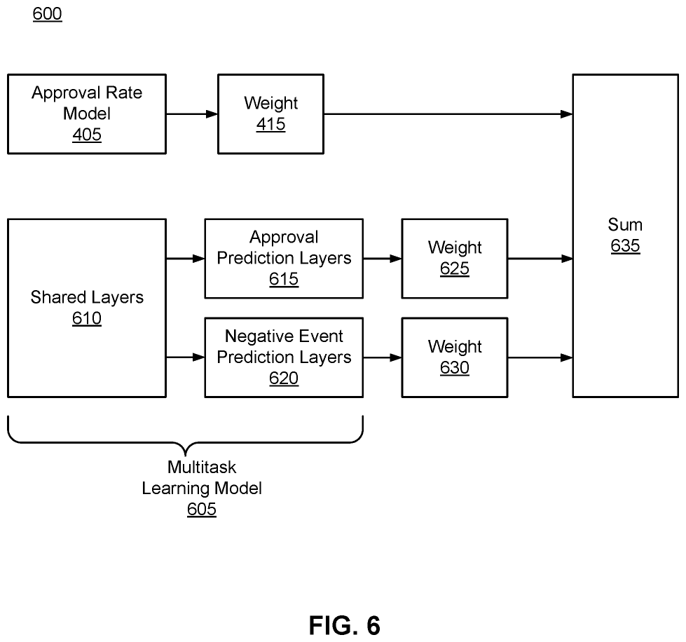

While FIGS. 4 and 5 illustrate example attribute selection models including multiple sub-models predicting probabilities of different actions occurring (e.g., approval of a replacement item by a customer, a negative event from replacing an item with a replacement item), in other embodiments, FIG. 6 illustrates an attribute selection model 600 including a multitask learning model 605. The attribute selection model 600 shown in FIG. 6 includes the approval rate model 405, further described above in conjunction with FIGS. 4 and 5, and the multitask learning model 605. In other embodiments, the attribute selection model 600 includes different or additional models.

As further described above in conjunction with FIGS. 4 and 5, the replacement selection model receives a pair of an item and a candidate replacement item as input. The approval rate model 405 determines the approval score as a ratio of a number of indications of positive feedback for replacing the item with the candidate replacement item to a number of times the item was replaced with the candidate replacement item. Additionally, the approval rate model 405 determines a probability of one or more negative events occurring for the pair of item and candidate replacement item. In various embodiments, the approval rate model 405 determines the probability of one or more negative events occurring by dividing a number of negative events that previously occurred from replacing the item with the candidate replacement item by a sum of the number of negative events that previously occurred and a number of positive events that previously occurred from replacing the item with the candidate replacement item, as further described above in conjunction with FIG. 4. In some embodiments, the approval rate model 405 generates non-negative event probability by subtracting the probability of the negative event occurring from one and generating the approval score as a product of the ratio and a value based on the non-negative event probability, as further described above in conjunction with FIGS. 4 and 5.

The multitask learning model 605 includes a set of shared layers 610, with each shared layer including one or more weights. In some embodiments, the set of shared layers 610 generates an embedding for the item and an embedding for the candidate replacement item, as further described above in conjunction with FIGS. 4 and 5. For example, the set of shared layers 610 receives item attributes of the item and item attributes of the candidate replacement item and generates an embedding for the item and an embedding for the candidate replacement item based on their respective item attributes.

The embedding for the item and the embedding for the candidate replacement item are input into different task-specific sets of layers. In the example shown by FIG. 6, the multitask learning model 605 includes a set of approval prediction layers 615 that output a predicted probability of a customer approving replacement of the item with the candidate replacement item, and a set of negative event prediction layers 620 that output a predicted probability of a negative event occurring in response to replacing the item with the candidate replacement item. As further described above in conjunction with FIGS. 3-5, a “negative event” occurs when the online concierge system 140 receives negative feedback from the customer when the candidate replacement item is included in the order in place of the item or when the online concierge system 140 receives a request for a refund for the candidate replacement item when included in an order in place of the item. In various embodiments, the set of approval prediction layers 615 comprises a Siamese network (or a twin network) that applies common weights to the embedding for the item and the embedding for the candidate replacement item to generate a predicted probability of a customer approving replacement of the item with the candidate replacement item. Similarly, the set of negative event prediction layers 620 also comprises an additional Siamese network (or a twin network) that applies common weights to the embedding for the item and the embedding for the candidate replacement item to generate a predicted probability of a negative event occurring in response to replacing the item with the candidate replacement item.

The online concierge system 140 generates a training dataset for the multitask learning model 605 that includes training examples based on previously fulfilled orders. The training examples include a set of approval training examples each including an approval item and an approval replacement item, with an approval label applied to an approval training example indicating whether a customer approved replacing the item with the replacing item. Additionally, the training examples include a set of negative event training examples each including a negative event item and a negative event replacement item, with a negative event label applied to a negative event training example indicating whether a negative event occurred when the negative event replacement item replaced the negative event item.

The online concierge system 140 applies the multitask learning model 605 to each training example in the training dataset. The online concierge system 140 maintains an approval loss function for the set of approval prediction layers 615 and a negative loss function of the set of negative event prediction layers 620. When the multitask learning model 605 is applied to a training example, the approval loss function generates an approval error term based on a difference between a predicted probability of a customer approving replacement of an item in the training example with a replacement item in the training example generated by the set of approval prediction layers 615 and a label applied to the training example. Similarly, the negative event loss function generates a negative event error term based on a difference between a predicted probability of a negative event occurring when in response to replacing the item in the training example with the replacement item in the training example generated by the set of negative event prediction layers 620 and a label applied to the training example. The online concierge system scores the multitask learning model 605 by combining the approval error term and the negative event error term. For example, the online concierge system applies different weights to the approval error term and to the negative event error term and sums the weighted approval error term and the weighted negative event error term to generate a score for the multitask learning model 605. While the score may be a linear combination of the approval error term and the negative event error term in some embodiments, in other embodiments the score is determined through other types of combinations of the approval error term and the negative event error term.

The online concierge system 140 backpropagates the score through the multitask learning model 605 to update the set of parameters comprising the multitask learning model 605 and stops backpropagation in response to the score satisfying one or more criteria. For example, the online concierge system 140 backpropagates the score through the multitask learning model 605 to update parameters of the multitask learning model until the score has less than a threshold value. For example, the online system 140 may apply gradient descent to update the set of parameters. The online concierge system 140 stores the set of parameters comprising the multitask learning model 605 on a non-transitory computer readable storage medium after stopping the backpropagation. This allows the online concierge system 140 to determine a predicted probability of the customer approving replacement of an item with a candidate replacement item and a predicted probability of a negative event occurring from replacing the item with the candidate replacement item using a single predictive model, the multitask learning model 605.

When applied to a pair of an item and a candidate replacement item, the replacement selection model 600 sums 635 the approval score from the approval rate model 405 weighted by a weight 415, the predicted probability of the customer approving replacement of the item with the candidate replacement item output by the set of approval prediction layers 615 weighted by weight 625, and an output of the set of negative event prediction layers 620 by weight 630 to generate a replacement score for the candidate replacement item. The output of the set of negative event prediction layers 620 may be a predicted probability of a negative event occurring when the item is replaced by the candidate replacement item, in which case weight 630 has an opposite sign than weight 415 and weight 625. Alternatively, the output of the set of negative event prediction layers 620 is inferred probability of a negative event not occurring determined by subtracting the predicted probability of a negative event occurring when replacing the item with the candidate replacement item from one, weight 630, weight 415 and weight 625 each have a common sign.

In other embodiments, the replacement selection model differently combines outputs of the approval rate model 405, outputs of the set of approval prediction layers 615, and outputs of the set of negative event prediction layers 620 to generate a replacement score for the candidate replacement item, as further described above in conjunction with FIGS. 4 and 5. Based on replacement scores for different candidate replacement items, the online concierge system 140 selects one or more candidate replacement items, as further described below in conjunction with FIG. 3. The replacement score for a candidate replacement item accounts for likelihoods of the customer approving use of the candidate replacement item in place of an item and of a negative event occurring from replacing the item with the candidate replacement item to decrease a frequency of negative events occurring when selecting candidate replacement items for the item.

Referring back to FIG. 3, the online concierge system 140 selects 325 one or more candidate replacement items of the set based on the scores generated 320 for each candidate replacement item of the set. In some embodiments, the online concierge system 140 ranks the candidate replacement items of the set based on their corresponding scores and selects 325 one or more candidate replacement items having at least a threshold position in the ranking. For example, the online concierge system 140 generates a ranking where candidate replacement items having larger scores have higher positions in the ranking and selects 325 candidate replacement items having at least a threshold position in the ranking. Alternatively, the online concierge system 140 selects 325 one or more candidate replacement items having at least a threshold score.

The online concierge system 140 displays 330 the selected one or more candidate replacement items to a user associated with the order. For example, the online concierge system 140 transmits instructions for generating an interface displaying one or more of the selected candidate replacement items to a customer client device 100 of the customer from whom the order was received. The customer may identify a particular candidate replacement item for replacing the unavailable item through interaction with the interface via the customer client device 100. In some embodiments, the interface displays the selected candidate replacement items in an order based on their corresponding scores. For example, the interface displays selected candidate replacement items with higher scores in more prominent positions in the interface, while displaying selected candidate replacement items with lower scores in less prominent positions in the interface.

Alternatively or additionally, the online concierge system 140 transmits instructions for generating an interface displaying one or more of the selected candidate replacement items to a picker client device 110 of a picker fulfilling the order. In some embodiments, the interface displays the selected candidate replacement items to the picker in an order based on their corresponding scores. For example, the interface displays selected candidate replacement items with higher scores in more prominent positions in the interface, while displaying selected candidate replacement items with lower scores in less prominent positions in the interface. Displaying the selected candidate replacement items in an order based on their score increases a likelihood of the picker replacing the unavailable item with a candidate replacement item that the customer will approve, while reducing the probability of a negative event occurring from replacement of the unavailable item.

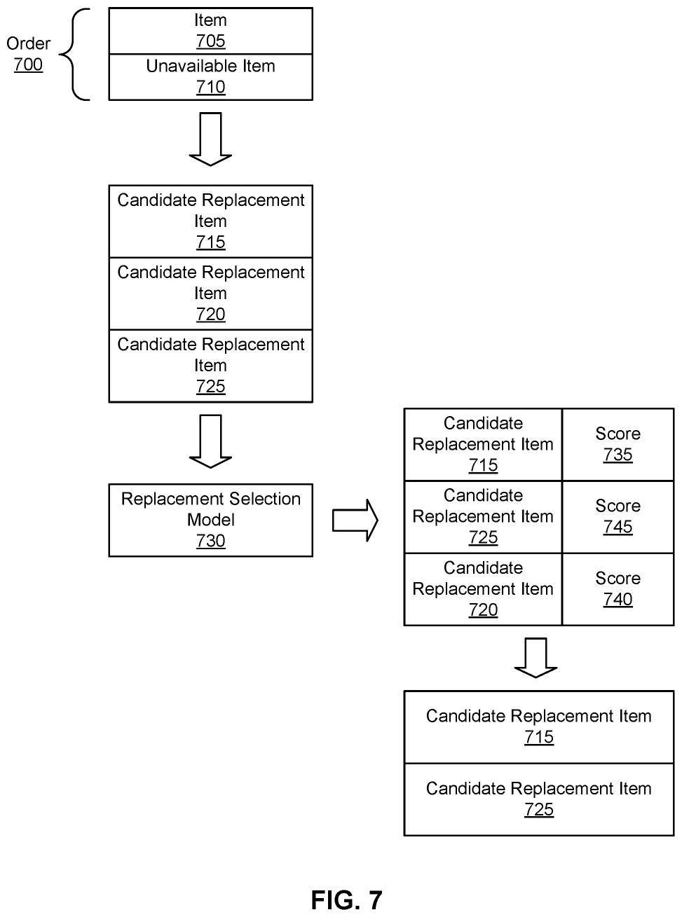

FIG. 7 is a process flow diagram of a method for selecting one or more candidate replacement items for an unavailable item in an order. As shown in FIG. 7, an online concierge system 140 receives an order 700 from a customer. The order 700 includes one or more items and identifies a retailer from which the one or more items are to be obtained. In various embodiments, the order 700 includes a location and a time interval for delivery of the one or more items included in the order 700, although different or additional information may be included in the order in various embodiments. The online concierge system 140 allocates the order to a picker, who obtains the items included in the order 700 from the retailer identified by the order.

As the picker obtains items included in the order 700 from the retailer identified by the order 700, the picker fulfilling the order 700 is affected by availability of different items in the order 700. In the example of FIG. 7, item 705 included in the order 700 is available at the identified retailer, but the order 700 also includes an unavailable item 710. The unavailable item 710 is out of stock at the retailer identified by the order 700. Alternatively, the online concierge system 140 determines the unavailable item 710 has less than a threshold predicted availability at the retailer identified by the order 700 based on application of a trained availability prediction model to the unavailable item 710 and the retailer identified by the order 700. As another example, a picker transmits an indication to the online concierge system 140 that the picker is unable to locate the unavailable item 710 at the retailer identified by the order 700.

To prevent revenue loss from refunding the customer for the picker being unable to obtain the unavailable item 710, the online concierge system 140 allows the picker to replace the unavailable item 710 with a replacement item. To simplify selection of a replacement item, the online concierge system 140 obtains a set of candidate replacement items for the unavailable item 710. In the example of FIG. 7, the set of candidate replacement items includes candidate replacement item 715, candidate replacement item 720, and candidate replacement item 725. However, in other embodiments, the set of candidate replacement items includes any number of candidate replacement items. In some embodiments, candidate replacement item 715, candidate replacement item 720, and candidate replacement item 725 each have a common item category as the unavailable item 710. Alternatively, each of candidate replacement item 715, candidate replacement item 720, and candidate replacement item 725 were each included in one or more prior orders as a replacement for the unavailable item 710.

The online concierge system 140 applies a replacement selection model 730, further described above in conjunction with FIGS. 3-6, to each pair of the unavailable item 710 and a candidate replacement item. Application of the replacement selection model 730 to a pair of the unavailable item 710 and a candidate replacement item generates a score for the candidate replacement item. As further described above in conjunction with FIGS. 3-6, the replacement selection model 730 generates a score for a candidate replacement item as a weighted sum of predicted probabilities of different events occurring when the candidate replacement item is included in the order 700 in place of the unavailable item 710. For example, the replacement selection model 730 determines an approval score for a candidate replacement item based on a number of times customers of the online concierge system 140 previously approved replacing the unavailable item 710 with the candidate replacement item. The replacement selection model 730 also generates a predicted probability of the customer approving replacement of the unavailable item 710 with the candidate replacement item based on item attributes of the unavailable item 710 and the candidate replacement item.

One or more of the events for which the replacement selection model 730 predicts probabilities are negative events, so the replacement selection model 730 accounts for potential negative reaction of the customer to inclusion of a candidate replacement item in the order 700 in place of the unavailable item. In various embodiments, a “negative event” comprises the online concierge system 140 receiving negative feedback from the customer when the candidate replacement item is included in the order 700 in place of the unavailable item 710 of the online concierge system 140 receiving a request for a refund for the candidate replacement item when included in the order 700 in place of the unavailable item 710. As further described above in conjunction with FIGS. 3-6, the replacement selection model 730 determines a probability of one or more negative events occurring based on a number of negative events that previously occurred from replacing the unavailable item 710 with the candidate replacement item in prior orders and a number of positive events that previously occurred from replacing the unavailable item 710 with the candidate replacement item in prior orders. In some embodiments, the replacement selection model 730 also determines a predicted probability of one or more negative events occurring based on item attributes of the unavailable item 710 and of the candidate replacement item.

The replacement selection model 730 applies different weights to each of the determined probabilities or the predicted probabilities and combines the weighted probabilities or weighted predicted probabilities to generate the score for a candidate replacement item. In various embodiments, weights applied to probabilities or predicted probabilities for negative events have a different sign than weights applied to probabilities or predicted probabilities for other events. This allows the replacement selection model 730 to attenuate the probabilities or predicted probabilities for events other than negative events by likelihoods of one or more negative events occurring. Accounting for probabilities of negative events occurring allows the online concierge system 140 to reduce a likelihood of negative events occurring when selecting candidate replacement items for the unavailable item 710, while maximizing a likelihood of a customer approving a selected candidate replacement item (or taking another action with the selected replacement item).

In the example of FIG. 7, applying the replacement selection model 730 to each pair of the unavailable item 710 and candidate replacement item 715, candidate replacement item 720, and candidate replacement item 725 generates score 735 for candidate replacement item 715, score 740 for candidate replacement item 720, and score 745 for candidate replacement item 725. Based on the scores 735, 740, 745, the online concierge system 140 selects one or more of candidate replacement item 715, candidate replacement item 720, and candidate replacement item 725. For example, the online concierge system 140 selects two candidate replacement items from the set of candidate replacement items based on their corresponding scores. In the example of FIG. 7, the online concierge system 140 ranks candidate replacement item 715, candidate replacement item 720, and candidate replacement item 725 based on their scores and selects candidate replacement items having at least a second position in the ranking. For purposes of illustration, FIG. 7 shows an example where score 735 is greater than score 745, while score 740 is less than score 735 and score 745, so the online concierge system 140 selects candidate replacement item 715 and candidate replacement item 725 from a ranking based on the scores 735, 740, 745. In other embodiments, the online concierge system 140 uses other criteria to select one or more candidate replacement items based on corresponding scores or selects another number of candidate replacement items.

The online concierge system displays the selected one or more candidate replacement items to a user of the computer system associated with the order. For example, the online concierge system 140 transmits instructions for generating an interface displaying candidate replacement item 725 and candidate replacement item 725 to a customer client device 100 of the customer from whom the order 700 was received. Alternatively or additionally, the online concierge system 140 transmits instructions for generating an interface displaying candidate replacement item 715 and candidate replacement item 725 to a picker client device 110 of a picker fulfilling the order 700. In some embodiments, candidate replacement item 715 and candidate replacement item 725 are displayed in an order based on their corresponding scores, with a candidate replacement item having a higher score having a more prominent position in the interface, increasing a likelihood of the picker or the customer replacing the unavailable item with a candidate replacement item less likely to result in a negative event when replacing the unavailable item 710.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
receiving an order at the computer system from a user device of a user, the order identifying one or more items and a retailer from which the one or more items are to be obtained;
identifying an unavailable item in the order;
obtaining a set of candidate replacement items for the unavailable item;
generating a score for each candidate replacement item of the set by applying a replacement selection model to each pair of the unavailable item and a candidate replacement item, the replacement selection model determining a score for the candidate replacement item based on a weighted sum of predicted probabilities for each of a set of events that includes one or more negative events, with a negative weight applied to predicted probabilities of negative events;
selecting one or more candidate replacement items based on the generated scores; and
sending the selected candidate replacement items to the user device of the user associated with the order, wherein sending the selected candidate replacement items causes the user device to display the selected candidate replacement items and an option for accepting one or more of the selected candidate replacement items to be added to the order in place of the unavailable item.

2. The method of claim 1, wherein generating the score for each candidate replacement item of the set by applying the replacement selection model comprises:
generating an approval score for the candidate replacement item based on a number of times users of the computer system previously approved replacing the unavailable item with the candidate replacement item and a probability of one or more negative events occurring determined from a number of negative events that previously occurred from replacing the unavailable item with the candidate replacement item and a number of positive events that previously occurred from replacing the unavailable item with the candidate replacement item; and
generating a predicted probability of the user approving replacement of the unavailable item with the candidate replacement item by applying an event prediction model to the unavailable item and to the candidate replacement item, the event prediction model trained by:
obtaining a training dataset including a plurality of training examples, each training example including a combination of an item and a replacement item, each training example having a label indicating whether one or more users previously approved replacing the item with the replacement item;
applying the event prediction model to each training example of the training dataset to generate a predicted probability of the user approving replacing the item with the replacement item;
scoring the event prediction model using a loss function and the label of the training example; and
updating one or more parameters of the event prediction model by backpropagation based on the scoring until one or more criteria are satisfied; and
generating the score for the candidate replacement item as a sum of the approval score weighted by a weight and the predicted probability of the user approving replacement of the unavailable item with the candidate replacement item weighted by an additional weight.

3. The method of claim 2, wherein generating the approval score for the candidate replacement item comprises:
determining a ratio of a number of times users of the computer system previously approved replacing the unavailable item with the candidate replacement item to a number of time the unavailable item was replaced in prior orders;
determining the probability of one or more negative events occurring determined by dividing a number of negative events that previously occurred from replacing the unavailable item with the candidate replacement item by a sum of the number of negative events that previously occurred from replacing the unavailable item with the candidate replacement item and a number of positive events that previously occurred from replacing the unavailable item with the candidate replacement item; and
determining the approval score for the candidate replacement item as a product of the ratio and a result from subtracting the probability of the negative event occurring from one.

4. The method of claim 2, wherein generating the approval score for the candidate replacement item comprises:
determining the probability of one or more negative events occurring determined by dividing a number of negative events that previously occurred from replacing the unavailable item with the candidate replacement item by a sum of the number of negative events that previously occurred from replacing the unavailable item with the candidate replacement item and a number of positive events that previously occurred from replacing the unavailable item with the candidate replacement item; and
determining the approval score as a ratio of a number of times users of the computer system previously approved replacing the unavailable item with the candidate replacement item to a number of times the unavailable item was replaced in prior orders.

5. The method of claim 4, wherein generating the score for the candidate replacement item as the sum of the approval score weighted by the weight and the predicted probability of the user approving replacement of the unavailable item with the candidate replacement item weighted by the additional weight comprises:
generating the score for the candidate replacement item as a sum of the approval score weighted by the weight, the predicted probability of the user approving replacement of the unavailable item with the candidate replacement item weighted by the additional weight, and the probability of one or more negative events occurring weighted by an alternative weight having a different sign than the weight and the additional weight.

6. The method of claim 4, wherein generating the score for the candidate replacement item as the sum of the approval score weighted by the weight and the predicted probability of the user approving replacement of the unavailable item with the candidate replacement item weighted by the additional weight comprises:
generating a non-negative event probability of the one or more negative events not occurring by subtracting the probability of one or more negative events occurring from one; and
generating the score for the candidate replacement item as a sum of the approval score weighted by the weight, the predicted probability of the user approving replacement of the unavailable item with the candidate replacement item weighted by the additional weight, and the non-negative event probability weighted by an alternative weight.

7. The method of claim 1, wherein generating the score for each candidate replacement item of the set by applying the replacement selection model comprises:
generating an approval score for the candidate replacement item based on a number of times users of the computer system previously approved replacing the unavailable item with the candidate replacement item and a probability of one or more negative events occurring determined from a number of negative events that previously occurred from replacing the unavailable item with the candidate replacement item and a number of positive events that previously occurred from replacing the unavailable item with the candidate replacement item; and
generating a predicted probability of a user approving replacement of the item with the candidate replacement item by applying an approval prediction model to the unavailable item and to the candidate replacement item, the approval prediction model trained by:
obtaining an approval training dataset including a plurality of approval training examples, each approval training example including a combination of an approval training item and an approval training replacement item, each approval training example having an approval training label indicating whether one or more users previously approved replacing the approval training item with the approval training replacement item;
applying the approval prediction model to each approval training example of the approval training dataset to generate a predicted probability of the user approving replacing the approval training item with the approval training replacement item;
scoring the approval prediction model using a loss function and the approval training label of the approval training example; and
updating one or more parameters of the approval prediction model by backpropagation based on the scoring until one or more criteria are satisfied;
generating a predicted probability of a negative event occurring in response to replacing the item with the candidate replacement item by applying a negative event prediction model to the unavailable item and to the candidate replacement item, the negative event prediction model trained by:
obtaining a negative training dataset including a plurality of negative training examples, each negative training example including a combination of a negative training item and a negative training replacement item, each negative training example having a negative training label indicating whether one or more negative events occurred in response to previously replacing the negative training item with the negative training replacement item;
applying the negative event prediction model to each negative training example of the negative training dataset to generate a predicted probability of one or more negative events occurring in response to replacing the negative training item with the negative training replacement item;
scoring the negative event prediction model using a loss function and the negative training label of the negative training example; and
updating one or more parameters of the negative event prediction model by backpropagation based on the scoring until one or more criteria are satisfied; and
generating the score for the candidate replacement item as a sum of the approval score weighted by a weight, the predicted probability of the user approving replacement of the unavailable item with the candidate replacement item weighted by an additional weight, and the predicted probability of the negative event occurring in response to replacing the item with the candidate replacement item weighted by an alternative weight having a different sign than the weight and the additional weight.

8. The method of claim 1, wherein selecting one or more candidate replacement items based on the generated scores comprises:
ranking the candidate replacement items of the set based on corresponding scores; and
selecting one or more candidate replacement items having at least a threshold position in the ranking.

9. The method of claim 1, wherein displaying the selected one or more candidate replacement items to the user of the computer system associated with the order comprises:
transmitting instructions to a user client device of the user from whom the order was received to display an interface including the selected one or more candidate replacement items.

10. The method of claim 1, wherein displaying the selected one or more candidate replacement items to the user of the computer system associated with the order comprises:
transmitting instructions to a picker client device of a picker fulfilling the order to display an interface including the selected one or more candidate replacement items.

11. The method of claim 1, wherein predicting the probabilities of negative events comprises predicting probabilities of one or more of:
the computer system receiving negative feedback from the user when the candidate replacement item is included in the order in place of the unavailable item, or
the computer system receiving a request for a refund for the candidate replacement item when included in the order in place of the unavailable item.

12. A computer program product comprising a non-transitory computer readable storage medium having instructions encoded thereon that, when executed by a processor, cause the processor to perform steps comprising:
receiving an order from a user device of a user, the order identifying one or more items and a retailer from which the one or more items are to be obtained;
identifying an unavailable item in the order;
obtaining a set of candidate replacement items for the unavailable item;
generating a score for each candidate replacement item of the set by applying a replacement selection model to each pair of the unavailable item and a candidate replacement item, the replacement selection model determining a score for the candidate replacement item based on a weighted sum of predicted probabilities for each of a set of events that includes one or more negative events, with a negative weight applied to predicted probabilities of negative events;
selecting one or more candidate replacement items based on the generated scores; and
sending the selected candidate replacement items to the user device of the user associated with the order, wherein sending the selected candidate replacement items causes the user device to display the selected candidate replacement items and an option for accepting one or more of the selected candidate replacement items to be added to the order in place of the unavailable item.

13. The computer program product of claim 12, wherein generating the score for each candidate replacement item of the set by applying the replacement selection model comprises:
generating an approval score for the candidate replacement item based on a number of times users previously approved replacing the unavailable item with the candidate replacement item and a probability of one or more negative events occurring determined from a number of negative events that previously occurred from replacing the unavailable item with the candidate replacement item and a number of positive events that previously occurred from replacing the unavailable item with the candidate replacement item; and
generating a predicted probability of a user approving replacement of the item with the candidate replacement item by applying an event prediction model to the unavailable item and to the candidate replacement item, the event prediction model trained by:
obtaining a training dataset including a plurality of training examples, each training example including a combination of an item and a replacement item, each training example having a label indicating whether one or more users previously approved replacing the item with the replacement item;
applying the event prediction model to each training example of the training dataset to generate a predicted probability of the user approving replacing the item with the replacement item;
scoring the event prediction model using a loss function and the label of the training example; and
updating one or more parameters of the event prediction model by backpropagation based on the scoring until one or more criteria are satisfied; and
generating the score for the candidate replacement item as a sum of the approval score weighted by a weight and the predicted probability of the user approving replacement of the unavailable item with the candidate replacement item weighted by an additional weight.

14. The computer program product of claim 13, wherein generating the score for the candidate replacement item as the sum of the approval score weighted by the weight and the predicted probability of the user approving replacement of the unavailable item with the candidate replacement item weighted by the additional weight comprises:
generating non-negative event probability of the one or more negative events not occurring by subtracting the probability of one or more negative events occurring from one; and
generating the score for the candidate replacement item as a sum of the approval score weighted by the weight, the predicted probability of the user approving replacement of the unavailable item with the candidate replacement item weighted by the additional weight, and the non-negative event probability weighted by an alternative weight.

15. The computer program product of claim 12, wherein generating the score for each candidate replacement item of the set by applying the replacement selection model comprises:
generating an approval score for the candidate replacement item based on a number of times users previously approved replacing the unavailable item with the candidate replacement item and a probability of one or more negative events occurring determined from a number of negative events that previously occurred from replacing the unavailable item with the candidate replacement item and a number of positive events that previously occurred from replacing the unavailable item with the candidate replacement item; and
generating a predicted probability of a user approving replacement of the item with the candidate replacement item by applying an approval prediction model to the unavailable item and to the candidate replacement item, the approval prediction model trained by:
obtaining an approval training dataset including a plurality of approval training examples, each approval training example including a combination of an approval training item and an approval training replacement item, each approval training example having an approval training label indicating whether one or more users previously approved replacing the approval training item with the approval training replacement item;
applying the approval prediction model to each approval training example of the approval training dataset to generate a predicted probability of the user approving replacing the approval training item with the approval training replacement item;
scoring the approval prediction model using a loss function and the approval training label of the approval training example; and
updating one or more parameters of the approval prediction model by backpropagation based on the scoring until one or more criteria are satisfied;
generating a predicted probability of a negative event occurring in response to replacing the item with the candidate replacement item by applying a negative event prediction model to the unavailable item and to the candidate replacement item, the negative event prediction model trained by:
obtaining a negative training dataset including a plurality of negative training examples, each negative training example including a combination of a negative training item and a negative training replacement item, each negative training example having a negative training label indicating whether one or more negative events occurred in response to previously replacing the negative training item with the negative training replacement item;
applying the negative event prediction model to each negative training example of the negative training dataset to generate a predicted probability of one or more negative events occurring in response to replacing the negative training item with the negative training replacement item;
scoring the negative event prediction model using a loss function and the negative training label of the negative training example; and
updating one or more parameters of the negative event prediction model by backpropagation based on the scoring until one or more criteria are satisfied; and
generating the score for the candidate replacement item as a sum of the approval score weighted by a weight, the predicted probability of the user approving replacement of the unavailable item with the candidate replacement item weighted by an additional weight, and the predicted probability of the negative event occurring in response to replacing the item with the candidate replacement item weighted by an alternative weight having a different sign than the weight and the additional weight.

16. The computer program product of claim 12, wherein selecting one or more candidate replacement items based on the generated scores comprises:
ranking the candidate replacement items of the set based on corresponding scores; and
selecting one or more candidate replacement items having at least a threshold position in the ranking.

17. The computer program product of claim 12, wherein displaying the selected one or more candidate replacement items to the user associated with the order comprises:
transmitting instructions to a user client device of the user from whom the order was received to display an interface including the selected one or more candidate replacement items.

18. The computer program product of claim 12, wherein displaying the selected one or more candidate replacement items to the user associated with the order comprises:
transmitting instructions to a picker client device of a picker fulfilling the order to display an interface including the selected one or more candidate replacement items.

19. The computer program product of claim 12, wherein a negative event comprises receiving negative feedback from the user when the candidate replacement item is included in the order in place of the unavailable item or receiving a request for a refund for the candidate replacement item when included in the order in place of the unavailable item.

20. A system comprising:
a processor; and
a non-transitory computer readable storage medium having instructions encoded thereon that, when executed by the processor, cause the processor to perform steps comprising:
receiving an order at the computer system from a user device of a user, the order identifying one or more items and a retailer from which the one or more items are to be obtained;
identifying an unavailable item in the order;
obtaining a set of candidate replacement items for the unavailable item;
generating a score for each candidate replacement item of the set by applying a replacement selection model to each pair of the unavailable item and a candidate replacement item, the replacement selection model determining a score for the candidate replacement item based on a weighted sum of predicted probabilities for each of a set of events that includes one or more negative events, with a negative weight applied to predicted probabilities of negative events;
selecting one or more candidate replacement items based on the generated scores; and
sending the selected candidate replacement items to the user device of the user associated with the order, wherein sending the selected candidate replacement items causes the user device to display the selected candidate replacement items and an option for accepting one or more of the selected candidate replacement items to be added to the order in place of the unavailable item.
